(19) United States
(12) Patent Application Publication
(10) Pub. No.: US 2013/0054929 A1
(43) Pub. Date: Feb. 28, 2013

(54) MOBILE TERMINAL AND OPERATION METHOD FOR THE SAME BASED ON MEMORY STATE CHANGES

(71) Applicants: Kun Hoon BAIK, Seoul (KR); Woong Suk Cho, Seoul (KR); Won Il Choi, Seoul (KR); Jong Hoon Han, Suwon-si (KR)

(72) Inventors: Kun Hoon BAIK, Seoul (KR); Woong Suk Cho, Seoul (KR); Won Il Choi, Seoul (KR); Jong Hoon Han, Suwon-si (KR)

(73) Assignee: Samsung Electronics Co., Ltd., Suwon-si (KR)

(21) Appl. No.: 13/592,923

(22) Filed: Aug. 23, 2012

(30) Foreign Application Priority Data
Aug. 23, 2011 (KR) 10-2011-0084003

(51) Int. Cl. G06F 12/02

(52) U.S. Cl. 711/170; 711/E12.002

(57) ABSTRACT

A mobile terminal and an operation method for the same based on memory state changes are provided. The operation method includes detecting a transition between memory states of a memory unit; performing operation control by placing and releasing memory usage restrictions on and from at least one of an application program previously loaded in the memory unit and an application program newly loaded in the memory unit based on the detected memory state transition.

### PRIORITY

This application claims priority under 35 U.S.C. §119(a) to an application filed in the Korean Intellectual Property Office on Aug. 23, 2011 and assigned Serial No. 10-2011-0084003, the entire disclosure of which is incorporated herein by reference.

### BACKGROUND OF THE INVENTION

1. Field of the Invention

The present invention relates generally to memory management of a mobile terminal and, more particularly, to a mobile terminal that supports efficient processing of functions on the basis of memory usage states and state changes and to a method for operating the same.

2. Description of the Related Art

With rapid technological advances, mobile terminals can now support not only basic voice calls and short text messages but also various other functions related to video calls, electronic schedulers and can access the Internet. To support a basic call-handling feature, mobile terminals provide a voice reception function, audio output function, screen display function and the like.

To support various functions, a mobile terminal stores programs and data in a memory unit. Thanks to recent technical advances, a large amount of data can be stored in a memory unit. However, since the size and complexity of programs and data needed to support user functions has been increasing, effective memory management has become more difficult. Specifically, since multitasking is required to execute multiple applications at the same time, the multitasking environment may tend to make efficient use of memory worse. Existing memory management schemes focusing on reduction of total memory usage fail to handle various problems caused by complex memory usage conditions, and fail to predict occurrences of memory shortage due to simplistic measurement such as measurement of a length of a certain program.

Thus, it is necessary to develop an efficient memory management scheme, which is more responsive to composite memory state changes, and a terminal operation method using the same.

### SUMMARY OF THE INVENTION

The present invention has been made in view of the above problems and the present invention provides a mobile terminal that efficiently supports memory management and usage control functions based on memory state changes and a method for operating the same.

In accordance with an embodiment of the present invention, a mobile terminal is provided. The terminal includes a memory unit for storing one or more application programs and data; and a control unit for controlling loading of an application program in the memory unit, wherein the control unit performs, when a transition between memory states is detected, performing operation control by at least one of a page reclamation and application termination on and from at least one of an application program previously loaded in the memory unit and an application program newly loaded in the memory unit based on the detected memory state transition.

In accordance with another embodiment of the present invention, a method for operating a mobile terminal based on memory state changes is provided. The method includes detecting a transition between memory states of a memory unit; performing operation control by placing and releasing memory usage restrictions on and from at least one of an application program previously loaded in the memory unit and an application program newly loaded in the memory unit based on the detected memory state transition.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating a mobile terminal according to an embodiment of the present invention;

FIG. 2 illustrates classification of memory states in an embodiment of the present invention;

FIG. 3 illustrates a control unit in the mobile terminal;

FIG. 4 illustrates a control unit;

FIG. 5 illustrates memory states and transitions in an embodiment of the present invention;

FIG. 6 illustrates a control unit;

FIG. 7 illustrates a priority manager in the control unit of FIG. 6;

FIG. 8 illustrates assignment of priority values;

FIG. 9 is a flowchart illustrating an operation method for the mobile terminal according to another embodiment of the present invention; and

FIG. 10 is a flowchart illustrating an operation method for the mobile terminal according to another embodiment of the present invention.

### DETAILED DESCRIPTION OF EMBODIMENTS OF THE PRESENT INVENTION

Hereinafter, embodiments of the present invention are described in detail with reference to the accompanying drawings. Detailed descriptions of well-known functions and structures incorporated herein may be omitted to avoid obscuring the subject matter of the present invention. The same reference symbols are used throughout the drawings to refer to the same or like parts. In the drawings, some elements are exaggerated or only outlined in brief, and thus may be not drawn to scale. The present invention is not limited by relative sizes of objects and intervals between objects in the drawings.

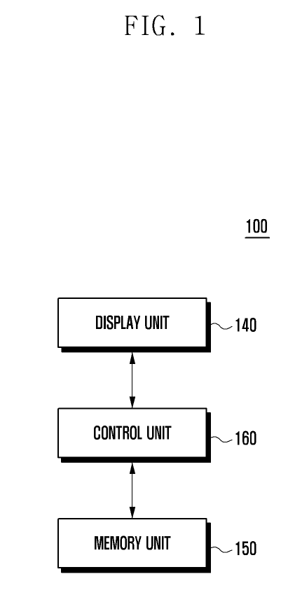

FIG. 1 is a block diagram illustrating a mobile terminal 100 supporting memory management according to an embodiment of the present invention.

Referring to FIG. 1, the mobile terminal 100 includes a display unit 140, a memory unit 150 and a control unit 160. The mobile terminal 100 includes a radio frequency unit to support mobile communication. The mobile terminal 100 includes a separate input unit to control various functions, and an audio processing unit to receive and reproduce an audio signal. Application programs and related data needed to support user functions are stored in the memory unit 150. Application programs include various routines implementing different user functions, and data includes data necessary for executing user functions and data generated in the course of executing user functions.

In the mobile terminal 100 including the above configuration, the control unit 160 performs or controls operations according to user requests or preset schedule information, and controls execution of programs on the basis of changes in the state of the memory unit 150.

The display unit 140 outputs various screens related to activation of application programs. In particular, the display unit 140 displays various information regarding state changes in the memory unit 150. The display unit 140 outputs not only screens related to currently active application programs but also information regarding application programs that are selected by the user but are currently deactivated. The display unit 140 outputs various screens related to utilization of the mobile terminal 100, such as an idle screen, menu screen, message composition screen, call-handling screen, ending screen and boot screen. The display unit 140 is implemented using a flat display panel based on Liquid Crystal Display (LCD) devices or Organic Light Emitting Diodes (OLED). The display unit 140 is configured to include a display panel and a touch panel. Specifically, the display unit 140 has a touchscreen capability so that the user can generate input signals using the display unit 140 to manipulate user functions. For example, when the user generates an input signal to invoke a specific function through the display unit 140, the input signal is sent to the control unit 160, which activates an application program implementing the function. Here, the application program selected by the input signal may be loaded in the memory unit 150.

The memory unit 150 provides a memory space in which various routines and programs needed to operate the mobile terminal 100 are loaded. The mobile terminal 100 includes a separate storage unit to store programs, or use a given region of the memory unit 150 as a storage space for storing programs. The memory unit 150 may be composed of various memory elements such as Random Access Memory (RAM) and flash memories.

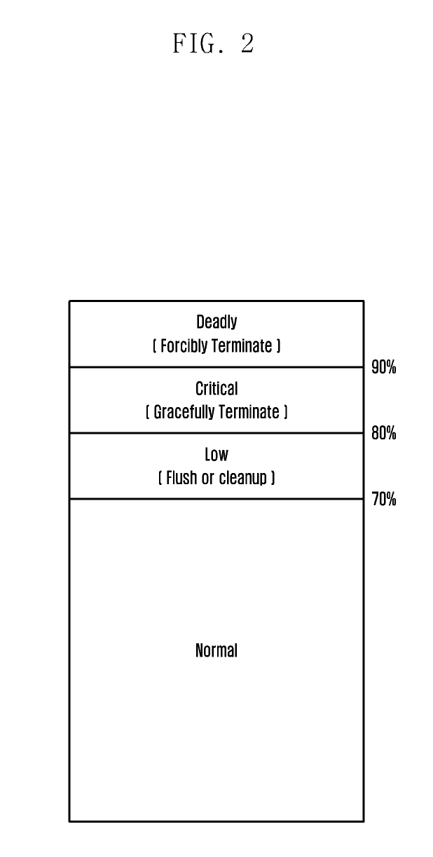

The memory unit 150 has various states depending on the types and sizes of loaded routine, code or programs and usage conditions. Memory states are specified in terms of memory usage, fragmentation and memory usage per unit time. Regarding memory usage, the total space of the memory unit 150 is 100 percent. Then, several memory states are specified as illustrated in FIG. 2: the “normal” state corresponds to a state in which 70 percent or less of the memory unit 150 is occupied by routines and data; the “low” state corresponds to a state in which 70 to 80 percent of the memory unit 150 is occupied by routines and data; the “critical” state corresponds to a state in which 80 to 90 percent of the memory unit 150 is occupied by routines and data; and the “deadly” state corresponds to a state in which 90 percent or more of the memory unit 150 is occupied by routines and data. In addition to the “normal”, “low”, “critical” and “deadly” states, additional memory states can be specified with reference to memory usage of, for example, 50 percent and 60 percent. The memory states classified above may also be named differently. Memory fragmentation is indicated as a ratio between the remaining memory capacity and the sum of large memory chunk sizes. For example, a fragmentation indicator may be computed by an equation such as “largest memory chunk size/remaining (available) memory capacity*100”. Fragmentation states are also classified into “fragmented” and “non-fragmented” states based on the value of the above equation. Memory fragmentation states are also classified in other ways. The memory usage per unit time is indicated by the amount of memory space changed for a given time duration (for example, “the amount of changed memory space/time interval”). The time unit is varied depending upon configuration settings. The memory usage per unit time can also be specified in other ways.

The control unit 160 loads data and routines needed to operate the mobile terminal 100 from the storage unit in the memory unit 150, and temporarily stores data generated in the course of operating the mobile terminal 100 in the memory unit 150. In response to an input signal for a specific function from the display unit 140 having a touchscreen capability or from a separate input unit, the control unit 160 supports the execution of a function requested by the input signal. To accomplish this, the control unit 160 reads an application program implementing the requested function from the storage unit and load the application program on the memory unit 150. When a change in the state of the memory unit 150 is caused by the loaded application program, the control unit 160 places restrictions on the execution of the requested function or on the execution of existing active application programs on the basis of a preset function-handling table. These control operations are described in detail later with reference to the drawings. The function-handling table contains information regarding restrictions imposed on application programs based on state changes of the memory unit 150.

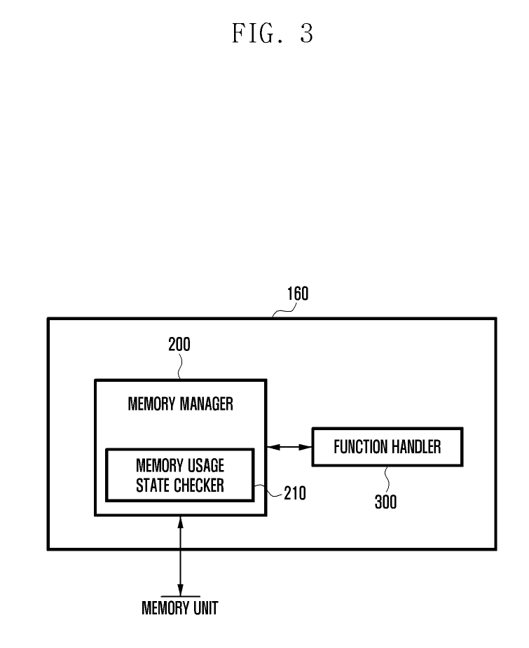

FIG. 3 illustrates the control unit 160 in the mobile terminal 100.

Referring to FIG. 3, the control unit 160 includes a memory manager 200 and a function handler 300.

In response to an input signal or event for a specific function from the input unit or the display unit 140 including a touchscreen capability, the function handler 300 controls activation of an application program implementing the function indicated by the input signal or event. To accomplish this, the function handler 300 has a program loader 310 to read a routine, code or a program implementing the requested function from the storage unit and load the routine, the code or the application program in the memory unit 150. Further, the function handler 300 has a control function unit 320 to activate the requested routine, code or program when the requested application program is already loaded in the memory unit 150 in a deactivated state. The control function unit 320 temporarily or semi-permanently stores data generated by the application program in the memory unit 150.

The memory manager 200 detects a change in the state of the memory unit 150 and places restrictions on application execution accordingly. A change in the state of the memory unit 150 may be caused by an application program newly activated by the function handler 300 or by data generated by an application program being executed. To accomplish this, the memory manager 200 includes a memory usage state checker 210.

The memory usage state checker 210 detects a change in the total usage of the memory unit 150. Specifically, the memory usage state checker 210 detects a transition between classified memory states. For example, the memory usage state checker 210 examines the usage state of the memory unit 150 to detect a transition between the “normal” state and the “low” state or a transition between the “low” state and the “critical” state. A transition between memory states occurs based on the generation or removal of data by an application program being executed, loading of a new application program or termination of an existing application program.

When a memory state transition is detected, the memory usage state checker 210 places restrictions on currently active user functions based on preset scheduling information. More specifically, when a transition from the “normal” state to the “low” state is detected (need for more memory), the memory usage state checker 210 controls an operation to forcibly terminate at least one of currently active application programs, unload at least one application program from the memory unit 150, or forcibly reclaim some of the memory space allocated to an application program. The memory usage state checker 210 selects at least one of the currently active application programs on the basis of priorities assigned thereto and forcibly terminates the selected application program or forcibly reclaim some of the memory space allocated thereto. Later, in reverse, when a transition from the “low” state to the “normal” state is detected (i.e., the need for less memory), the memory usage state checker 210 controls an operation to reload the unloaded application program in the memory unit 150, or reactivate the forcibly terminated application program. In addition, the memory usage state checker 210 controls to store a certain state of the application program when the application program deactivates in a memory state change callback. Further, the memory usage state checker 210 controls to restore the state of the application program when the application program reactivates.

As described above, the mobile terminal 100 capable of supporting multitasking can manage execution of multiple application programs based on state transitions of the memory unit 150 and operate in a stable way without a deadlock in utilization of the memory unit 150.

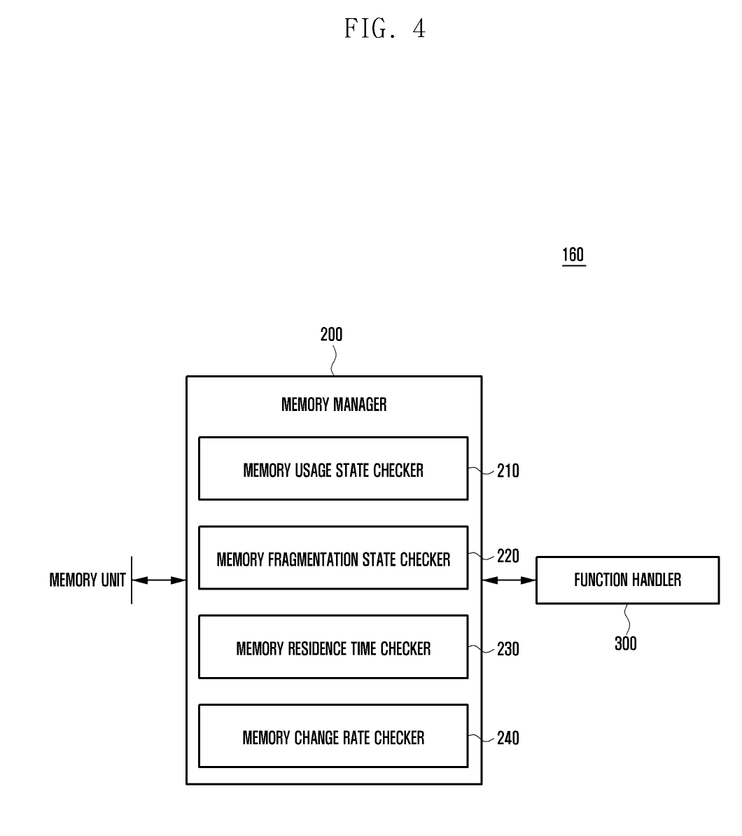

FIG. 4 illustrates a second embodiment of the control unit 160 in the mobile terminal 100.

Referring to FIG. 4, the control unit 160 includes a memory manager 200 and a function handler 300, and the memory manager 200 includes a memory usage state checker 210, a memory fragmentation state checker 220, a memory residence time checker 230, and a memory change rate checker 240.

The memory manager 200 of the control unit 160 efficiently performs memory management operations (for example, allocation of memory space to application programs that are currently active or to be activated) on the basis of information collected by the internal components. That is, the memory manager 200 manages the memory unit 150 on the basis of at least one of memory usage state information collected by the memory usage state checker 210, memory fragmentation state information collected by the memory fragmentation state checker 220, memory residence time information of loaded application programs and data collected by the memory residence time checker 230, and memory access information (related to read and write operations for loaded application programs and data) collected by the memory change rate checker 240. To manage the memory unit 150 utilizing the collected information, the memory manager 200 controls an operation to forcibly terminate an active application program, reclaim some of the memory space allocated to an application program, allocate more memory space to an application program, or reactivate a forcibly terminated application program. The memory manager 200 is also configured to include at least one of the memory usage state checker 210, a memory fragmentation state checker 220, a memory residence time checker 230, and a memory change rate checker 240.

The memory usage state checker 210 detects a change in the total usage of the memory unit 150. Specifically, the memory usage state checker 210 detects a transition between classified memory states. For example, the memory usage state checker 210 examines the usage state of the memory unit 150 to detect a transition between the “normal” state and the “low” state or a transition between the “low” state and the “critical” state. A transition between memory states occurs based on generation or removal of data by an application program being executed, loading of a new application program or termination of an existing application program.

When a memory state transition is detected, the memory usage state checker 210 places restrictions on execution of user functions based on preset scheduling information. More specifically, when a transition from “normal” state to “low” state is detected (i.e., the need for more memory), the memory usage state checker 210 controls an operation to forcibly terminate at least one currently active application program, unload at least one application program from the memory unit 150, or forcibly reclaim some of the memory space allocated to an application program. Here, the memory usage state checker 210 selects at least one of the currently active application programs on the basis of priorities assigned thereto and forcibly terminates the selected application program or forcibly reclaim some of the memory space allocated thereto. Later, in reverse, when a transition from the “low” state to the “normal” state is detected (i.e., the need for less memory), the memory usage state checker 210 controls an operation to reload the unloaded application program on the memory unit 150, or reactivate the forcibly terminated application program.

The memory residence time checker 230 examines a time duration during which a specific application program or data resides in the memory unit 150. When an application program is activated based on a user request or preset scheduling information, the application program is loaded in the memory unit 150. The loaded application program remains in the memory unit 150 until terminated. The memory residence time checker 230 examines a time duration in which a specific application program and related data remain in the memory unit 150. The collected memory residence time information may be reported to the memory manager 200.

The memory change rate checker 240 examines changes in the amount of used memory space per unit time. The memory change rate checker 240 logs the amount of used memory space at regular intervals, calculates a memory usage change rate at a given time, and reports the memory usage change rate to the memory manager 200. The memory usage change rate is used, as an estimate of memory space demand, to regulate the amount of reclaimed memory space. For example, although the amount of used memory space is not large, when the memory usage change rate is very high, the memory manager 200 increases the amount of reclaimed memory space to cope with the possibility of severe memory shortage in the near future. That is, in a multitasking environment, when multiple applications simultaneously make memory allocation requests, the memory usage change rate rapidly increases. This case requires the control unit 160 to carefully manage the demand for memory space.

The memory fragmentation state checker 220 examines the state of memory space allocated to application programs and data needed for functions of the mobile terminal 100. The memory space becomes more fragmented with time due to repeated memory allocation and deallocation as application programs are activated and terminated under control of the program loader 310 of the function handler 300. In other words, as the free memory is interspersed with blocks of memory in use due to repeated memory allocation and deallocation, the average size of memory blocks becomes smaller. Small memory blocks that are free (i.e., unused) are practically unusable. This is because a contiguous memory block of a suitable size is needed to load a new application program. Consequently, the program loader 310 of the function handler 300 determines that a load request for an application program cannot be satisfied because it has failed to find a contiguous memory block even though the size of total free memory exceeds the requested size. The program loader 310 issues a command for memory defragmentation or memory compaction to rearrange memory blocks of the memory unit 150. The memory fragmentation state checker 220 identifies the current fragmentation state based on the distribution of contiguous memory blocks, and detect a transition between classified fragmentation states.

As described above, the memory manager 200 manages memory space of the memory unit 150 on the basis of memory usage state information, memory fragmentation state information, memory residence time information, memory usage change rate information, and a combination thereof. That is, memory manager 200 controls a process of memory allocation, deallocation and reallocation, and adjustment of memory allocation units using the above information.

States classified based on a first criterion such as memory usage are combined with states classified based on a second criterion such as memory fragmentation. The memory manager 200 detects a transition between composite states and performs a memory management operation corresponding to the detected transition. The number of composite states vary based on the number of state checkers and the number of states classified by each state checker.

In addition to memory usage state information, memory fragmentation state information, memory residence time information, and memory usage change rate information, the memory manager 200 uses memory access frequency information to manage the memory unit 150. The memory manager 200 includes a memory access frequency checker (not shown) to collect information on memory access frequencies. Composite states are defined on the basis of two or more types of information selected from among memory usage state information, memory fragmentation state information, memory residence time information, memory usage change rate information, and memory access frequency information. The memory manager 200 detects a transition between the composite states and performs a corresponding memory management operation.

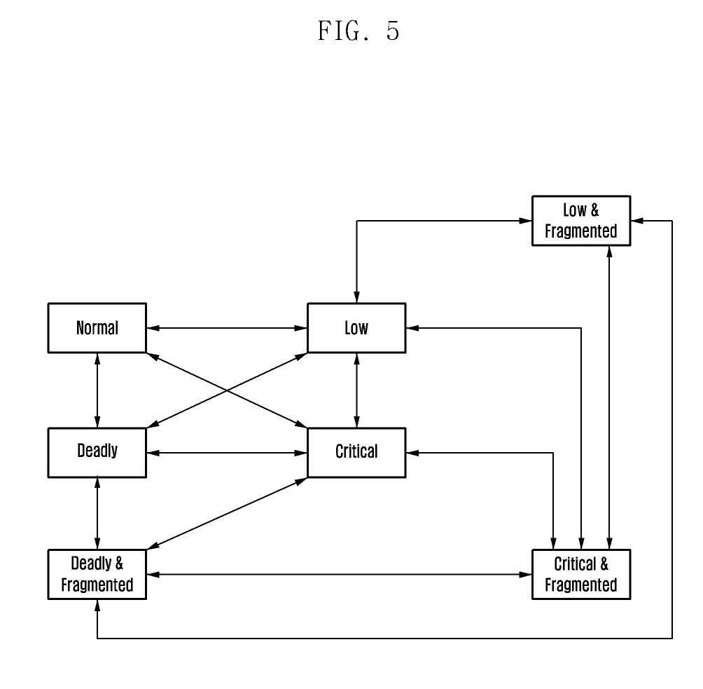

The memory manager 200 manages composite state changes (transitions) on the basis of various types of information collected by multiple memory state checkers working in parallel. Thus, it is possible to cope with various types of changes occurring in the memory unit 150 in a flexible and responsive way. Memory management based on composite state changes is described in more detail with reference to FIG. 5.

FIG. 5 illustrates memory states and transitions in the present invention.

Referring to FIG. 5, the “normal”, “low”, “critical” and “deadly” states are defined for the memory unit 150 based on memory usage state information as described above, and a “fragmented” state may be further defined based on memory fragmentation state information. The “fragmented” state corresponds to a state in which memory space of the memory unit 150 is excessively fragmented (for example, the number or size of contiguous memory blocks is too small). Thus, composite states “low and fragmented”, “critical and fragmented” and “deadly and fragmented” are defined as shown in FIG. 5. The memory manager 200 identifies memory states on the basis of information from the memory usage state checker 210 and information from the memory fragmentation state checker 220.

For example, the memory manager 200 detects a transition between the “normal” state and the “low” state or between the “low” state and the “critical” state, and performs a memory management operation corresponding to the detected state transition. As described before, restrictions on memory usage are placed on or removed from application execution. Moreover, when a transition between the “critical” state and the “critical and fragmented” state or between the “low and fragmented” state and the “critical and fragmented” state is detected, the memory manager 200 performs corresponding memory management operations. That is, the memory manager 200 identifies memory management operations and application control operations pre-specified for memory state transitions, and perform a suitable set of memory management and application control operations based on a detected state transition.

The memory manager 200 performs finer memory management and application control operations using information collected by the usage state checker 210, memory fragmentation state checker 220 and memory residence time checker 230. For example, when the “deadly” state persists for a given period of time or more, the memory manager 200 performs memory management and application control operations on the basis of information collected by the memory residence time checker 230. The memory manager 200 forcibly terminates an application program that has remained in the memory unit 150 for a long time and occupies a large amount of memory space or reclaim some memory space from the application program.

Additionally, the collected information is also used in the following situations. For example, although the amount of used memory space is not large, when the memory usage change rate rises sharply, the memory manager 200 increases the amount of reclaimed memory space to deal with the possibility of a severe memory shortage in the near future. Some or all of the memory space allocated to an application program not being executed is reclaimed in advance to deal with the possibility of severe memory shortage. As another example, when the memory usage change rate is high while the memory unit 150 is severely fragmented, the amount of free memory is increased by terminating a suitable application program. Memory compaction is ineffective because a long time is needed to perform the operation. When the memory usage change rate is low while the memory unit 150 is severely fragmented, the amount of free memory is increased through memory compaction.

As described above, the memory manager 200 defines various memory states on the basis of at least one of memory usage state information, memory fragmentation state information, memory residence time information, memory usage change rate information, and memory access frequency information, and supports various application control operations for each memory state. Thus, the control unit 160 allocates sufficient memory space to a selected application program to avoid unnecessary memory allocation and enable the efficient and stable utilization of the memory unit 150.

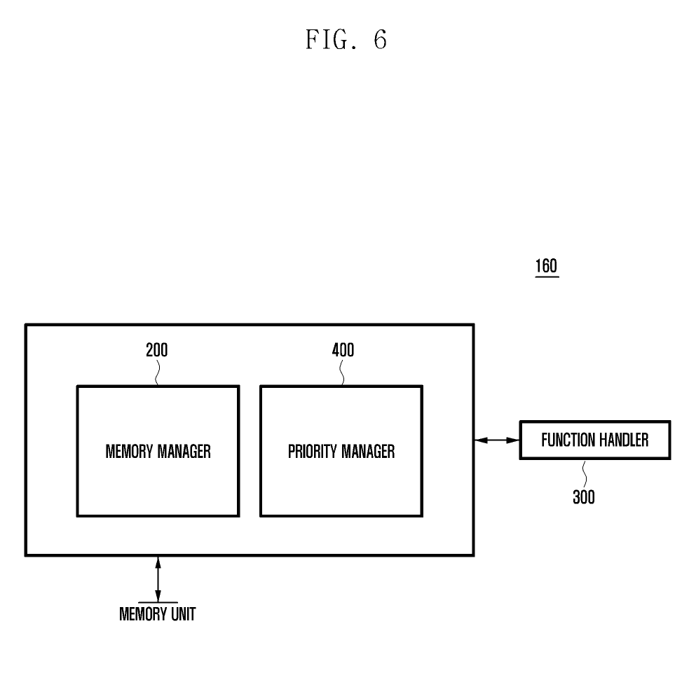

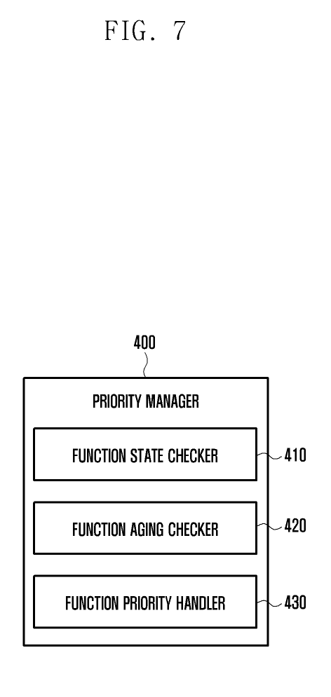

FIG. 6 illustrates the control unit 160. FIG. 7 illustrates a priority manager 400 in the control unit 160 of FIG. 6.

Referring to FIG. 6, the control unit 160 includes a memory manager 200, a priority manager 400 and a function handler 300.

The memory manager 200 includes at least one of the memory usage state checker 210, memory fragmentation state checker 220, memory residence time checker 230 and memory change rate checker 240 described before, and receives memory management information including at least one of memory usage state information, memory fragmentation state information, memory residence time information and memory usage change rate information from these components. The priority manager 400 identifies information on priorities assigned to application programs that are currently active or to be activated and reports the priority information to the memory manager 200. The priority manager 400 identifies current states of application programs processed by the function handler 300 and adjust priorities of the application programs based on their current states. The memory manager 200 determines memory management operations and application control operations on the basis of priority information from the priority manager 400 and memory management information. That is, using the memory management information and the priority information, the memory manager 200 controls an operation to forcibly terminate at least one of application programs that are currently active or to be activated, reclaim some of the memory space allocated to an application program, or reload or reactivate the forcibly terminated application program. Hence, the control unit 160 applies different control operations to different application programs based on the priority information. The memory manager 200 delegates control authority to the function handler 300 instead of directly controlling application programs.

The function handler 300 has the program loader 310 and the control function unit. The program loader 320 loads an application program supporting a specific user function in the memory unit 150 and the control function unit 320 activates the loaded application program based on a user's request or preset scheduling information. The control function unit 320 receives memory state information from the memory manager 200 and performs application control operations using the received memory state information. That is, using memory management information from the memory manager 200 and priority information from the priority manager 400, the control function unit 320 controls an operation to forcibly terminate at least one of application programs having a given priority, reclaim some of the memory space allocated to an application program, or reload or reactivate the forcibly terminated application program.

The control function unit 320 of the function handler 300 provides priority-based application control information to a specific application program. An application program that is loaded in the memory unit 150 and processed by the function handler 300 performs operation control based the memory management information from the memory manager 200 and the priority assigned to the application program. The application program performs a memory management operation such as forced termination, memory reclamation or memory reallocation through callback functions. To accomplish this, the control unit 160 provides a function-handling table that specifies memory management routines based on priority information and memory management information, and permits an application program to invoke the memory management routines as callback functions. Such a function-handling table that specifies memory management functions based on priority information and memory management information are implemented and changed in various ways based on terminal design and application design.

The priority manager 400 manages priorities of application programs that are currently active or will be activated based on a preset schedule or user request. As shown in FIG. 7, the priority manager 400 includes a function state checker 410, a function-aging checker 420, and a function priority handler 430.

The function state checker 410 identifies the current state of an application program loaded in the memory unit 150. A loaded application program is in one of a foreground state, a background state and a wait state. When an application program is in the foreground state, it can generate screen interaction and directly respond to an input signal from the input unit or the display unit 140 having a touchscreen capability. When an application program is in the background state, it does not generate screen interaction or directly respond to an input signal from the input unit or the display unit 140. An application program in the foreground state may be placed in the background state or vice-versa in response to a preset input signal from the input unit or the display unit 140 having a touchscreen capability. The mobile terminal 100 provides a key or key map for generating an input signal causing an application program to transition between the foreground state and the background state.

Additionally, a loaded application program is in an active state or in an inactive state. Hence, the function state checker 410 identifies one of four composite states in which an application program loaded in the memory unit 150 may be placed.

The function-aging checker 420 collects information on the memory residence time of an application program in the active or inactive state. That is, the function-aging checker 420 identifies the time at which an application program is loaded in the memory unit 150. The function-aging checker 420 performs a function similar to that of the memory residence time checker 230 of the memory manager 200, or receives memory residence time information from the memory residence time checker 230 and forwards the same to the priority manager 400.

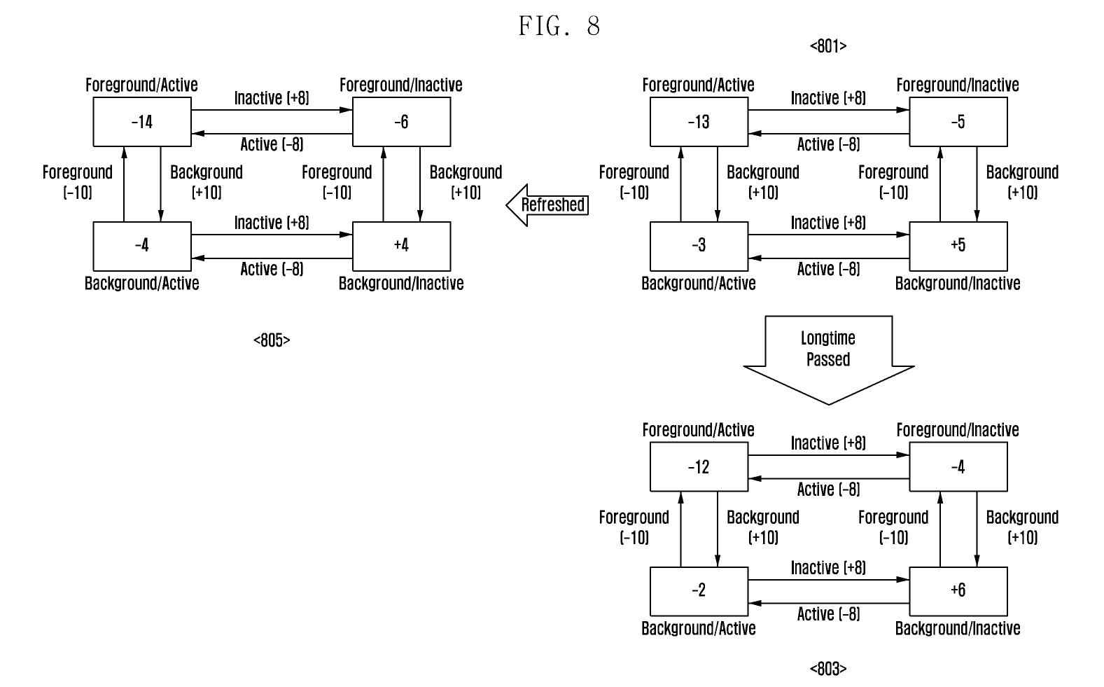

The function priority handler 430 assigns priority values to application programs based on their states, and adjusts priority values assigned to application programs based on state transitions. The function priority handler 430 adjusts priority values assigned to application programs on the basis of at least one of memory residence time information from the function-aging checker 420, original priority information of the application programs before the priority values are assigned, and information on an input event or input signal for selecting an application program or controlling the mobile terminal 100. Priority management is described in more detail with reference to FIG. 8.

FIG. 8 illustrates priority management for application programs.

Referring to FIG. 8, as indicated by reference symbol 801, an application program loaded in the memory unit 150 is in one of four composite states: the foreground and active state, the foreground and inactive state, the background and active state, and the background and inactive state.

For priority management, the priority manager 400 assigns priority to a loaded application program on a state basis. For example, the priority manager 400 assigns a priority of −8 to an application program in the active state, assigns a priority of +8 to an application program in the inactive state, assigns a priority of −10 to an application program in the foreground state, and assigns a priority of +10 to an application program in the background state. It is assumed that a smaller priority value indicates higher priority. Moreover, the priority manager 400 assigns a priority of −5 to an application program in the foreground and inactive state, assigns a priority of −13 to an application program in the foreground and active state, assigns a priority of +5 to an application program in the background and inactive state, and assigns a priority of −3 to an application program in the background and active state.

After a given period of time from initial priority assignment indicated by reference symbol 801 passes, the priority manager 400 adjusts the priority of the loaded application program as indicated by reference symbol 803. That is, the priority manager 400 lowers the priority of the loaded application program as time passes. If the priority manager 400 increases the priority value by +1, the application program has a priority of −4 while in the foreground and inactive state, a priority of −12 while in the foreground and active state, a priority of −2 while in the background and active state, and a priority of +6 while in the background and inactive state.

When an application program loaded in the memory unit 150 is refreshed after initial priority assignment indicated by reference symbol 801, the priority manager 400 raises the priority of the loaded application program as indicated by reference symbol 805. For example, when the mobile terminal 100 transitions from a sleep state to a wake-up state, the priority of loaded application programs is raised. If the priority manager 400 decreases the priority value by +1, the application program has a priority of −6 while in the foreground and inactive state, a priority of −14 while in the foreground and active state, a priority of −4 while in the background and active state, and a priority of +4 while in the background and inactive state. This priority adjustment gives scheduling preference to already loaded application programs over an application program to be loaded.

As described above, the priority manager 400 assigns different priorities to each application program loaded in the memory unit 150 while in different states classified by the presence of screen interaction and activation state.

The priority manager 400 assigns intrinsic priorities to application programs based on type, and determines the overall priority of an application program by combining the intrinsic priority and state-based priority. For example, the priority manager 400 assigns higher intrinsic priorities to call or communication handling application programs in comparison to other application programs. Thereafter, when the memory state changes in the course of operating the mobile terminal 100, the priority manager 400 determines the overall priority of an application program by adding the intrinsic priority and state-based priority of the application program.

The control function unit 320 of the function handler 300 performs application control operations on the basis of priority information provided by the priority manager 400. For example, when the memory state becomes worse, the control function unit 320 places memory usage restrictions on application programs having lower priorities. When the memory state improves, the control function unit 320 removes memory usage restrictions from application programs having higher priorities. In other words, when the memory state worsens, the control function unit 320 controls an operation to forcibly terminate an application program having a low priority or reclaim some memory space thereof first. Memory reclamation may limit execution of the corresponding application program. When the memory state improves (for example, a transition from “critical” to “normal” state), the control function unit 320 controls an operation to allocate more memory space to an application program having a high priority first among application programs that have been forcibly terminated or have forcibly lost memory space.

The priority manager 400 assigns a state-based priority to an application program that is to be loaded in the memory unit 150 based on an input signal or preset scheduling information in a similar manner to the above-described scheme. For example, the priority manager 400 assigns a priority of −13 to a newly loaded application program while in the foreground and active state, and assigns a priority of −3 to the newly loaded application program while in the background and active state. The overall priority of the newly loaded application program is determined using the state-based priority and intrinsic priority. The memory manager 200 and control function unit 320 of the function handler 300 selects an application program to which application control operations are to be applied from among the application programs that are already loaded or newly loaded on the basis of priority information. For example, in the event that the memory state worsens to such an extent so as to forcibly terminate an application program, when the newly loaded application program has the lowest priority, the memory manager 200 and control function unit 320 deactivates the newly loaded application program and output an alert message indicating activation failure to the display unit 140. When the newly loaded application program has a higher priority than that of an already loaded application program, the memory manager 200 and control function unit 320 forcibly terminates the already loaded application program and activate the newly loaded application program.

Components and their functions for effective memory management in the mobile terminal 100 have been described in relation to memory states, transitions between memory states, and application control based on memory states. Also, a description was given of components and their functions for determining application control operations based on priority information of loaded application programs. Next, a description will be given of a method for operating a mobile terminal on the basis of memory state changes.

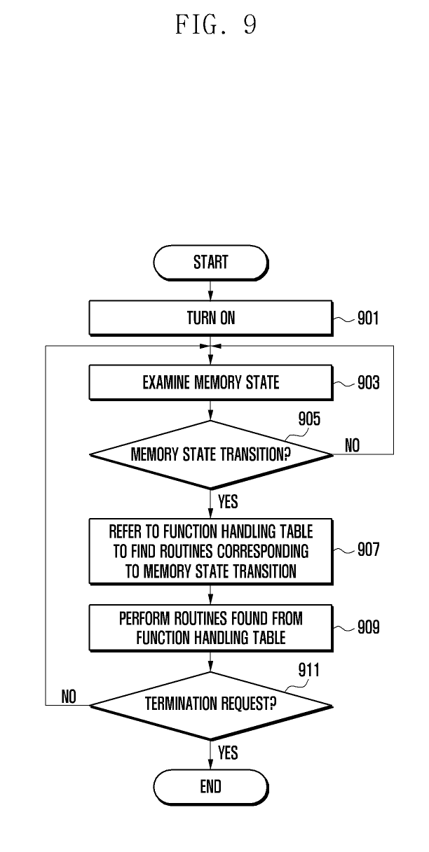

FIG. 9 is a flowchart of an operation method for the mobile terminal 100 based on another embodiment of the present invention.

Referring to FIG. 9, the mobile terminal 100 is turned on in step 901. Upon turning on, power is supplied to the components of the mobile terminal 100. The control unit 160 initializes the components, and loads basic programs needed for proper operation of the mobile terminal 100, such as the operating system, a communication handling program, a display control program and a screen-handling program. The control unit 160 automatically loads application programs pre-specified by user settings in the memory unit 150. Thereafter, the user makes an activation request for a desired function such as file search, web access or file playback.

The control unit 160 examines the state of the memory unit 150 in step 903. Here, the control unit 160 checks the status of memory allocation to application programs and data in the course of operating the mobile terminal 100. The control unit 160 checks for the occurrence of a transition between memory states the 905. That is, the control unit 160 checks whether the memory state worsens or improves. When a memory state transition has not occurred, the control unit 160 returns to step 903 and continues to process user requests.

When a memory state transition (for example, a transition from “normal” to “low” state or a transition from “low” to “critical” state) has occurred, the control unit 160 refers to the function-handling table to find application control routines corresponding to the memory state transition in step 907. The function-handling table contains various routines for memory management and application control classified by memory state transitions. For example, the function-handling table contains a routine for forcibly terminating a given application program, a routine for reclaiming some memory space allocated to a given application program, a routine for reloading or reactivating a forcibly terminated application program, and a routine for allocating more memory space to an application program some of whose memory space has been reclaimed. An application program some of whose memory space is reclaimed may be executed in a limited mode.

The control unit 160 controls an operation to perform the application control routines found from the function-handling table (909). Based on the memory state transition, the control unit 160 controls an operation to forcibly terminate a specific application program, reloads reload a forcibly terminated application program on the memory unit 150, reclaims some of memory space allocated to a specific application program, or allocates more memory space to an application program some of whose memory space has been reclaimed.

The control unit 160 checks whether a termination request is issued in step 911. When a termination request is not issued, the control unit 160 returns to step 903 and continues processing.

In addition to application control operations, the control unit 160 supports state-based memory management functions using various types of information on the memory unit 150. Specifically, multiple composite memory states are defined on the basis of memory usage state information, memory fragmentation state information, memory residence time information, memory usage change rate information, and memory access frequency information. The function-handling table further contains routines for memory management classified by composite memory states and transitions between the memory states. The control unit 160 controls an operation so that an application program can invoke memory management routines of the function-handling table corresponding to transitions between the composite memory states. Hence, application programs access the memory unit 150 in a stable and efficient way.

As described above, the method of FIG. 9 enables the mobile terminal 100 to perform various application control operations based on memory state transitions. When finer memory states are defined using various types of memory-related information, the mobile terminal 100 performs both memory management operations and application control operations based on memory states and transitions between the memory states. Hence, the mobile terminal 100 can perform efficient and fine-tuned memory management.

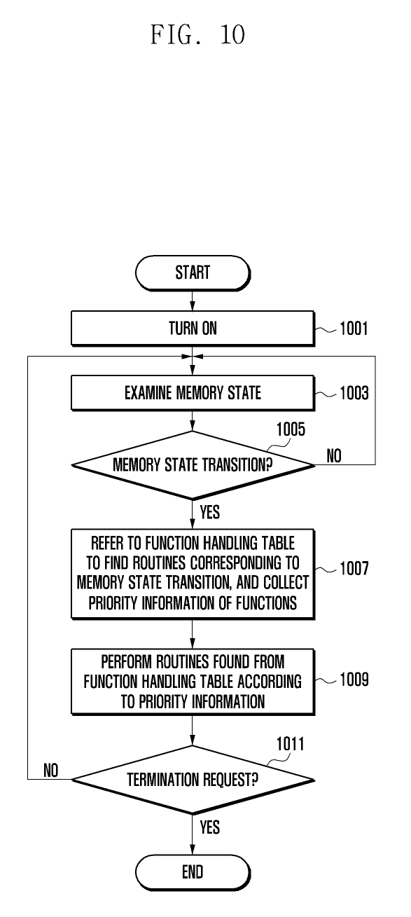

FIG. 10 is a flowchart of an operation method for the mobile terminal 100 based on another embodiment of the present invention.

Referring to FIG. 10, the mobile terminal 100 is turned on in step 1001. When the mobile terminal 100 is turned on, power is supplied to the components of the mobile terminal 100. The control unit 160 initializes the components, loads basic programs needed for the proper operation of the mobile terminal 100, loads application programs in the memory unit 150 based on user settings and preset scheduling information, and starts operation. The control unit 160 examines the state of the memory unit 150 in step 1003, and checks occurrence of a transition between memory states in step 1005. As steps 1001, 1003 and 1005 are similar to steps 901, 903 and 905 of FIG. 9, a detailed description thereof is omitted.

When a memory state transition has occurred, the control unit 160 refers to the function-handling table to find application control routines corresponding to the memory state transition, and collects priority information of terminal functions in step 1007. Here, the priority information of terminal functions is priority information of application programs that are already loaded and newly loaded in the memory unit 150. Priorities can be assigned and managed so that application programs having high priorities are less affected by memory management and application control operations than application programs having low priorities. As described above, each application program may have different priorities for different program states. That is, one application program may be in one of four composite states: the foreground and active state, the foreground and inactive state, the background and active state, and the background and inactive state. Application programs also have intrinsic priorities based on their types. The intrinsic priority of an application program is assigned when the application program is installed in the mobile terminal 100. Hence, the control unit 160 identifies the overall priority of an application program on the basis of at least one of the state-based priority and intrinsic priority.

The control unit 160 controls an operation to perform the application control routines found from the function-handling table based on the collected priority information in step 1009. That is, the control unit 160 determines an application program that should invoke the found application control routines on the basis of the priority information, and enable the determined application program to invoke the application control routines.

The control unit 160 checks whether a termination request is issued in step 1011. When a termination request is not issued, the control unit 160 returns to step 1003 and continues processing.

As described above, the method of FIG. 10 enables the mobile terminal 100 to determine memory management and application control operations based on memory states and transitions between the memory states and apply the determined memory management and application control operations to an application program selected based on priority information. Hence, the mobile terminal 100 can perform efficient and fine-tuned memory management. The method enables important application programs to stably occupy sufficient memory space by placing memory usage restrictions on less important application programs based on memory states and transitions between the memory states.

Although not shown, if necessary, the mobile terminal 100 includes at least one of a short-range communication module for short-range communication, a data communication interface based on wired and wireless communication, an Internet communication module for Internet access, and a digital broadcast receiving module for receiving digital broadcasts. With the digital convergence trend, it should be apparent to those skilled in the art that the mobile terminal 100 of the present invention includes a unit comparable to the above-described units, and one unit of the mobile terminal 100 may be removed or replaced with another unit.

The mobile terminal 100 of the present invention may be a device having a memory unit to support various functions, and may be any information and communication appliance or multimedia appliance, such as a mobile communication terminal based on communication protocols supporting various communication systems, a Portable Multimedia Player (PMP), a digital broadcast receiver, a Personal Digital Assistant (PDA), a music player like an MP3 player, a portable game console, a smart phone, a notebook computer, or a handheld computer.

In a feature of the present invention, the operation method enables a mobile terminal to be more responsive to memory state changes. Hence, the mobile terminal can efficiently support user functions through efficient memory management and effective operation control. Additionally, the operation method enables the mobile terminal to perform memory optimization in advance on the basis of accumulated information on composite memory state changes. Hence, the mobile terminal provides a more comfortable usage environment to the user.

While the present invention has been shown and described with reference to certain embodiments and drawings of the portable terminal, it will be understood by those skilled in the art that various changes in form and details may be made therein without departing from the spirit and scope of the invention as defined by the appended claims and their equivalents.

What is claimed is:

1. A method for operating a mobile terminal based on memory state changes, the method comprising:
detecting a transition between memory states of a memory unit;
performing operation control by at least one of a page reclamation and application termination on and from at least one of an application program previously loaded in the memory unit and an application program newly loaded in the memory unit based on the detected memory state transition.

2. The method of claim 1, wherein detecting a transition between memory states comprises at least one of:
examining memory usage state to identify a ratio of currently used memory to total memory capacity,
examining memory fragmentation state to identify memory allocation status,
examining memory residence times of application programs and data loaded in the memory unit,
examining the memory usage change rate, and
examining memory access frequencies in relation to application programs and data loaded in the memory unit.

3. The method of claim 2, further comprising:
detecting the transition between composite states based on at least one of memory usage state information, memory fragmentation state information, memory residence time information, memory usage change rate information, and memory access frequency information.

4. The method of claim 2, further comprising:
defining various memory states based on a plurality of types of information regarding the memory unit determined during transition detection; and
accessing a function-handling table that contains memory management and application control routines classified by the defined memory states and transitions between the memory states.

5. The method of claim 4, wherein performing operation control comprises:
one of forcibly terminating at least one of application programs that are previously loaded in the memory unit or newly loaded in the memory unit, reclaiming some memory space allocated to the application program, reloading or reactivating the forcibly terminated application program.

6. The method of claim 1, further comprising:
determining priority information regarding application programs that are previously loaded in the memory unit or newly loaded in the memory unit.

7. The method of claim 6, wherein determining priority information comprises at least one of:
assigning priority values to each application program for active, inactive, foreground and background states and adding the assigned priority values together to produce a state-based priority of the application program, and
identifying an intrinsic priority of each application program that is assigned to the application program when the application program is installed on the mobile terminal.

8. The method of claim 7, wherein determining priority information further comprises:
determining an overall priority of each application program by combining the state-based priority and the intrinsic priority.

9. The method of claim 6, wherein performing operation control comprises at least one of a page reclamation and application termination on and from the application programs in a differentiated manner based on the determined priority information.

10. A mobile terminal, the terminal comprising:
a memory unit for storing one or more application programs and data; and
a control unit for controlling loading of an application program in the memory unit,
wherein the control unit performs, when a transition between memory states is detected, operation control by placing and releasing memory usage restrictions on and from at least one of an application program previously loaded in the memory unit and an application program newly loaded based on the detected memory state transition.

11. The mobile terminal of claim 10, wherein the control unit comprises a memory manager that comprises at least one of:
a memory usage state checker examining memory usage state to identify a ratio of currently used memory to a total memory capacity,
a memory fragmentation state checker examining memory fragmentation state to identify memory allocation status,
a memory residence time checker examining memory residence times of application programs and data loaded in the memory unit, and
a memory change rate checker examining memory access frequencies in relation to application programs and data loaded in the memory unit.

12. The mobile terminal of claim 11, wherein the memory manager further comprises:
a current memory usage checker examining whether the ratio of currently used memory exceeds a preset level.

13. The mobile terminal of claim 11, wherein the memory manager defines various memory states on the basis of various types of information determined by the checkers, refers to a function-handling table that contains memory management and application control routines classified by the defined memory states and transitions between the memory states, and controls an operation to perform one of forcibly terminating at least one of application programs that are previously loaded in the memory unit or newly loaded in the memory unit, reclaiming some memory space allocated to the application program, reloading or reactivating the forcibly terminated application program.

14. The mobile terminal of claim 11, wherein the control unit further comprises:
a function handler that controls an operation to perform one of forcibly terminating at least one of application programs that are previously loaded in the memory unit or newly loaded in the memory unit, reloading or reactivating the forcibly terminated application program, and allocating more memory space to the application program some of whose memory space has been reclaimed, based on routines in a function-handling table that contains memory management and application control routines classified by memory states defined using various types of information determined by the checkers.

15. The mobile terminal of claim 10, wherein the control unit further comprises:
a priority manager for determining priority information regarding application programs that are previously loaded in the memory unit or newly loaded in the memory unit.

16. The mobile terminal of claim 15, wherein the priority manager comprises:
a function state checker for examining whether an application programs that is previously loaded in the memory unit or newly loaded in the memory unit is in an active state, an inactive state, a foreground state or a background state; and
a function priority handler for assigning priority values to each application program for the active, inactive, foreground and background states and summing the assigned priority values to produce a state-based priority of the application pro gram.

17. The mobile terminal of claim 16, wherein the priority manager further comprises:
a function-aging checker for determining information regarding memory residence times of application programs and data loaded in the memory unit.

18. The mobile terminal of claim 16, wherein the function priority handler identifies an intrinsic priority of each application program that is assigned to the application program when the application program is installed on the mobile terminal, and determines an overall priority of the application program by combining the state-based priority and the intrinsic priority.

19. The mobile terminal of claim 16, wherein the control unit places and releases memory usage restrictions on and from the application programs in a differentiated manner based on the determined priority information.

20. The mobile terminal of claim 19, wherein the control unit applies one of forcible termination, reclamation of memory space, reloading or reactivation based on the determined priority information.
